(19) United States
(12) Patent Application Publication
(10) Pub. No.: US 2005/0245106 A1
(43) Pub. Date: Nov. 3, 2005

(54) Land grid array-pin grid array connector

(75) Inventor: Hao-Yun Ma, Tu-Chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/097,075

(22) Filed: Mar. 31, 2005

(30) Foreign Application Priority Data
Apr. 30, 2004 (TW) 93112180

(51) Int. Cl. H01R 12/00

(52) U.S. Cl. 439/66

(57) ABSTRACT

A land grid array (LGA)-pin grid array (PGA) connector includes an insulative housing (20) and a number of electrical terminals (30) accommodated into the housing. Each of the terminals has a medial portion (32) with several tabs (320) to secure the terminal into the housing, a cantilever (364) extending from an upper portion of the medial portion and forming a contact portion (365) at a free end thereof for electrically contacting metal pad (42) of a central processing unit (CPU) (40), and a pin (34) extending from a lower portion of the medial portion for being inserted and soldered into a hole 52 of a printed circuit board (PCB) 50. A bridge portion (35) being curved configuration interconnects the medial portion with the pin, thus a distance in a horizontal direction between the medial portion and the pin is formed.

### BACKGROUND OF THE INVENTION

1. Field of the Invention

The invention is related to electrical connectors for electrically interconnecting electronics packages such as central processing units (CPUs) with circuit substrates such as printed circuit boards (PCBs), and particularly to a land grid array (LGA)-pin grid array (PGA) connector mounted onto a PCB by Through-Hole (TH) technology for electrically connecting a land grid array (LGA) CPU with the PCB.

2. Relating Art of the Invention

At present, electrical connectors are widely used to electrically and mechanically connect electronics packages such as land grid array (LGA) central processing units (CPUs) with circuit substrates such as printed circuit boards (PCBs). Such an electrical connector generally includes an insulative housing and a number of electrical terminals accommodated in the housing, as shown in U.S. Pat. No. 6,652,329. To decrease the cost of manufacture, the connector is assembled onto a PCB by Through-Hole (TH) technology. That is to say, pins of the terminals exposed out of a bottom side of the connector are inserted and soldered into holes defined in the PCB to mechanically and electrically connect the connector with the PCB. Each of the terminals has a cantilever forming a contact portion at a free end thereof to electrically touch the LGA CPU. Thus, an electrical connecting between the CPU and the PCB is established.

Such an LGA-PGA connector may have a problem in use. When the CPU presses the contact portions of the terminals of the connector, force on the cantilever of each of the terminals will form a horizontal moment relative to corresponding pin, and the connection between the pins and the PCB is unlikely to be reliable.

Therefore, a new LGA-PGA connector that can be reliably connected with a PCB by TH technology and manufactured at low cost is desired.

### SUMMARY OF THE INVENTION

A land grid array (LGA)-pin grid array (PGA) connector in accordance with a preferred embodiment of the invention is provided. The LGA-PGA connector includes an insulative housing and a number of electrical terminals accommodated in the housing. Each of the terminals has a medial portion with several tabs to secure the terminal in the housing, a cantilever extending from an upper portion of the medial portion and forming a contact portion at a free end thereof for electrically contacting a metal pad of a central processing unit (CPU), and a pin extending from a lower portion of the medial portion for being inserted and soldered into a hole of a printed circuit board (PCB). A bridge portion being curved configuration interconnects the medial portion with the pin, thus a distance in a horizontal direction between the medial portion and the pin is formed.

### BRIEF DESCRIPTION OF THE DRAWINGS

FIG. 1 is an isometric view of an electrical terminal of a land grid array (LGA)-pin grid array (PGA) connector in accordance with the preferred embodiment of the present invention;

FIG. 2 is an enlarged, top plan view of the terminal in FIG. 1;

FIG. 3 is a cross-section view of part of the LGA-PGA connector in accordance with the preferred embodiment of the present invention, together with a printed circuit board (PCB) assembled onto a bottom of the connector and a central processing unit (CPU) ready to assembled onto a top of the connector;

FIG. 4 is an enlarged, top plan view of part of the LGA-PGA connector in accordance with the preferred embodiment of the present invention;

FIG. 5 is an enlarged, cross-section view of part of the terminal and the PCB of FIG. 3, showing the pin assembled into the PCB viewed from another aspect;

FIG. 6 is similar to FIG. 3, but showing the CPU assembled onto the top of the connector;

FIG. 7 is an enlarged, top plan view of the terminal of FIG. 1; and

FIG. 8 is similar to FIG. 5, but showing a pin of an electrical terminal in accordance with an alternative embodiment of the present invention.

### DETAILED DESCRIPTION OF THE PREFERRED EMBODIMENT OF THE INVENTION

Reference will now be made to the drawings to describe the invention in detail.

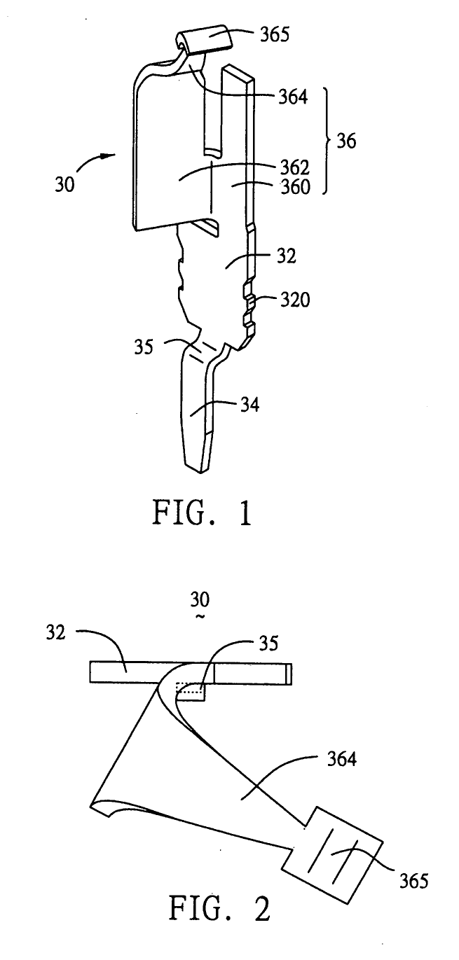

Referring to FIGS. 1 to 3, a land grid array (LGA)-pin grid array (PGA) connector, in accordance with the preferred embodiment of the present invention, is used for electrically connecting two electrical interfaces, e.g. a land grid array (LGA) central processing unit (CPU) 40, and e.g. a printed circuit board (PCB) 50. The CPU 40 has a plurality of metal pads 42 provided on a bottom side thereof. The PCB 50 defines a plurality of holes 52 arranged in an array. The connector comprises an insulative housing 20 and a plurality of electrical terminals 30 accommodated in the housing 20.

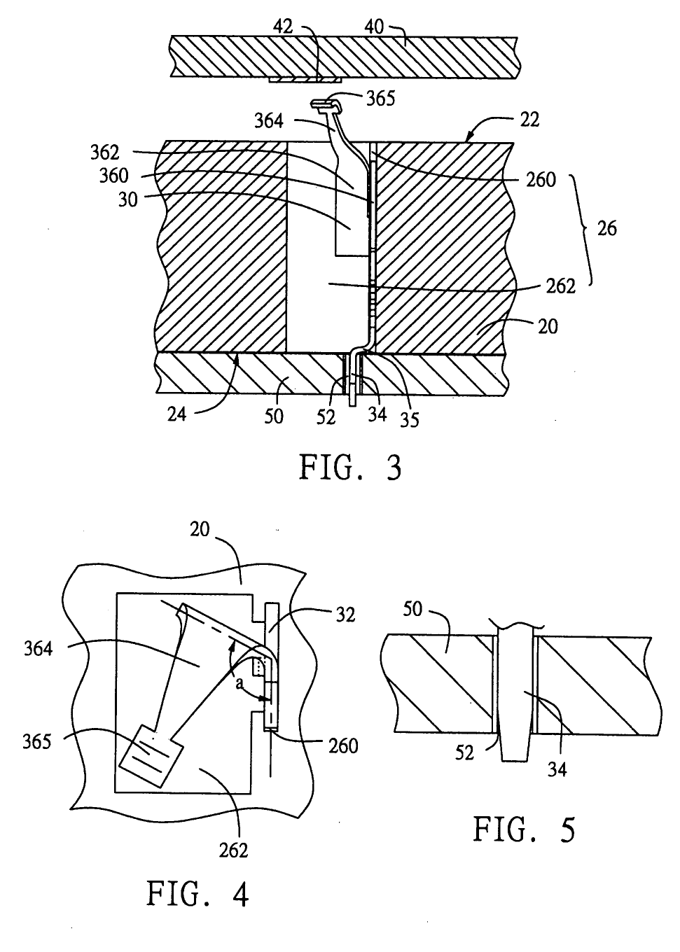

Referring to FIGS. 3 and 4, the housing 20 is generally rectangular, having an upper surface 22 for attaching the CPU 40 thereon and a lower surface 24 facing the PCB 50. The housing 20 defines a plurality of passageways 26 extending therethrough, for receiving the terminals 30 therein respectively. Each of the passageways 26 has a generally rectangular room 262 and an elongate room 260 in communication with the rectangular room 262.

The terminals 30 are stamped from a metal sheet. Each of the terminals 30 includes a medial portion 32, a mating portion 36 extending from an upper end of the medial portion 32, and a pin 34 for electrically connecting with the PCB 50.

The medial portion 32 is received in a lower portion of the elongated room 260 of one of the passageways 26. Several tabs 320 are formed at two opposite sides of the medial portion 32 of the terminal 30, the tabs 320 interfering with the housing 20 near the elongated room 260 to secure the terminal 30 in the passageway 26.

The mating portion 36 includes a base portion 360 extending from the upper end of the medial portion 32, an interconnecting portion 362 extending from a lower portion of the base portion 260, a cantilever 364 extending aslant from au upper end of the interconnecting portion 362, and a contact portion 365 formed at a free end of the cantilever 364. The base portion 360 and the medial portion 32 are located in a same plane, and a width of the base portion 360 is half of a width of the medial portion 32. A lower portion of a side of the interconnecting portion 362 is connected with a lower portion of a side of the base portion 360. The interconnecting portion 362 and the base portion 360 form an obtuse angle α. In the preferred embodiment of the present invention, α is 145 degrees such that the cantilever 364 extends upwardly in a diagonal of the passageway 26.

A bridge portion 35 is formed between the medial portion 32 and the pin 34, thus a distance in a horizontal direction between the pin 34 and the medial portion 32 is formed. The pin 34 is parallel to the medial portion 32 and located in a same side of the medial portion 32 with the cantilever 364. The bridge portion 35 may be a curve configuration, a horizontal configuration or a slant configuration. In the preferred embodiment of the invention, the bridge portion 35 is a curve configuration interconnecting the lower end of the medial portion 32 and an upper portion of the pin 34.

Referring to FIGS. 3 to 6, in manufacture, the terminals 30 are assembled into the housing 20 from a top side of the housing 20. In assembly, upper portions of the cantilevers 364 of the terminals 30 expose out of the upper surface 22 of the housing 20, for electrically contacting the CPU 40. The pins 34 expose out of the lower surface 24 of the housing 20, for electrically connecting with the PCB 50.

In use, the pins 34 of the terminals 30 are interferingly inserted and soldered into the holes 52 of the PCB 50 respectively to electrically connect the connector with the PCB 50. To facilitate to insert the pins 34 into holes 52, two bevels (not labeled) are formed at two opposite sides of ends of each of the pins 34. Referring to FIG. 8, in an alternative embodiment of the present invention, each pin 34′ defines a hole 340′ near an end thereof to increase the flexibility of the pin 34′ such that the pin 34′ is easily inserted into a hole 52′ of a PCB 50′.

The CPU 40 is attached onto the connector, with the metal pads 42 of the CPU 40 abutting against the contact portions 365 of the terminals 30 respectively. The CPU 40 is pressed down to provide forces F on the contact portions 365 of the terminals 30. The cantilevers 364 of the terminals 30 deflect down, and the contact portions 365 of the terminals 30 abuttingly contact the metal pads 42 of the CPU 40 to electrically connect the CPU 40 with the connector. Thus, an electrical connection between the CPU 40 and the PCB 50 is established by the connector.

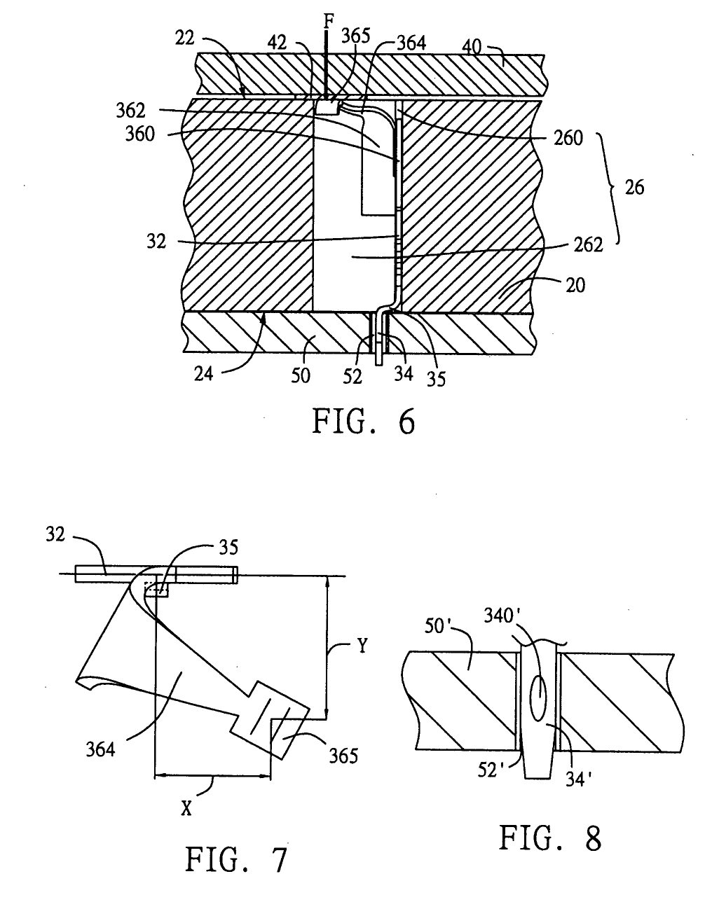

Referring to FIGS. 6 and 7, a distance X in a transverse direction and a distance Y in a lengthways direction are formed between the contact portion 365 of each of the terminals 30 and the medial portion 32, so the force on the contact portion 365 form a counter-clockwise moment at the medial portion 32. A distance (not labeled) in the lengthways direction is formed between the pin 34 of each terminal 30 and the medial portion 32, so a clockwise moment is formed at the medial portion 32 to decrease the affection of the counter-clockwise moment. Therefore, the terminals 30 are likely to secure in the housing 20 reliably, and the connections between the pins and the PCB are reliably.

From the foregoing it will be recognized that the principles of the invention may be employed in various arrangements to obtain the features, advantages and benefits described above. It is to be understood, therefore, that even though numerous characteristics and advantages of the invention have been set forth together with details of the structure and function of the invention, this disclosure is to be considered illustrative only. Various changes and modifications may be made in detail, especially in matters of size, shape and arrangements of parts, without departing from the spirit and scope of the invention as defined by the appended claims. For example, the bridge portion can extend farther and terminated right below the cantilever from a top view of the housing so as to have the offset pin precisely located under the cantilever from the top view for not only for compliance with different type printed circuit board but also enhancement of stability of the whole terminal in the corresponding passageway and between the printed circuit board and the CPU.

1. An electrical terminal comprising:
a medial portion interferingly secured in the passageway of the housing to secure the terminal into the housing;
a mating portion formed at an upper portion of the medial portion; the mating portion comprising:
a base portion extending upwardly from the upper portion of the medial portion;
an interconnecting portion connecting with the base portion;
a cantilever extending aslant from an upper portion of the interconnecting portion; and
a contact portion formed at a free end of the cantilever; and
a pin extending downwardly from a lower portion of the medial portion;
wherein a bridge portion is formed between the medial portion and the pin to interconnect the medial portion and the pin thereby the pin being parallel to the medial portion and located on a same side of the medial portion with the cantilever.

2. The LGA-PGA connector as claimed in claim 1, wherein the bridge portion is curved configuration.

3. The LGA-PGA connector as claimed in claim 1, wherein a lower portion of a side of the interconnecting portion connects with a lower portion of a side of the base portion.

4. The LGA-PGA connector as claimed in claim 3, wherein an obtuse angle is formed between the interconnecting portion and the base portion.

5. The LGA-PGA connector as claimed in claim 4, wherein the obtuse angle is 145 degrees.

6. A land grid array (LGA)-pin grid array (PGA) connector assembly comprising:
an LGA central processing unit (CPU) having a plurality of metal pads arranged on a bottom thereof;
a printed circuit board (PCB) defining a plurality of holes therethrough;
an LGA-PGA connector assembled onto the PCB and attaching the CPU thereon, the connector comprising:
an insulative housing forming an upper surface and a lower surface opposite to the upper surface, the housing defining a plurality of passageways extending through the upper surface and the lower surface; and
a plurality of electrical terminals accommodated into the passageways respectively, each of the terminals comprising:
a medial portion received in the passageway;
a cantilever formed at an upper portion of the medial portion;
a contact portion formed at a free end of the cantilever and exposed out of the upper surface of the housing to contact the metal pad of the CPU; and
a pin formed at a lower portion of the medial portion to be inserted and soldered into the hole of the PCB;
wherein a bridge portion is formed between the medial portion and the pin thereby a distance in a horizontal direction being formed between the pin and the medial portion.

7. The LGA-PGA connector assembly as claimed in claim 6, wherein the bridge portion is a curve configuration.

8. An electrical connector assembly for use with an electronic device having conductive pads on an undersurface thereof, comprising:
a printed circuit board defining a plurality of through holes; and
an electrical connector mounted upon the printed circuit board and including:
an insulative housing defining a plurality of passageways therein;
a plurality of terminals disposed in the corresponding passageways, respectively; each of said terminals defining:
a medial portion secured in the passageway of the housing to secure the terminal into the housing;
a mating portion formed at an upper portion of the medial portion an including a cantilever portion extending above an upper face of the housing from a side view of the housing and in an oblique direction relative to the medial portion from a top view of the housing;
a contact portion formed at a free end of the cantilever portion for mechanically and electrically engaging the corresponding conductive pad; and
a pin located around a lower portion of the medial portion and insertably soldered into the corresponding through hole in the printed circuit board;
wherein the through hole is intentionally offset from the corresponding medial section from the top view of the housing so the pin received in the corresponding through hole is also offset away from the medial portion from the top view of the housing; wherein
a bridge portion is connected between the medial portion and the pin and located on a same side of the medial portion with the cantilever portion.

9. The assembly as claimed in claim 8, wherein the pin is essentially located under the cantilever portion from the top view of the housing.
